(19) United States
(12) Patent Application Publication
(10) Pub. No.: US 2026/0077698 A1
(43) Pub. Date: Mar. 19, 2026

(54) DOOR AND RAMP ASSEMBLY COMBINATION FOR A TRAILER AND SYSTEM THEREOF

(71) Applicant: Forest River, Inc., Elkhart, IN (US)

(72) Inventors: Anthony Blanchard, Sturgis, MI (US); Matthew Henderson, Decatur, MI (US)

(21) Appl. No.: 19/332,790

(22) Filed: Sep. 18, 2025

Related U.S. Application Data
(60) Provisional application No. 63/696,500, filed on Sep. 19, 2024.

(51) Int. Cl. B60P 1/43; B60J 5/10; B62D 21/20; E05B 83/02; E05F 15/00

(52) U.S. Cl. CPC B60P 1/435; B60J 5/108; B62D 21/20; E05B 83/02; E05F 15/00; E05Y 2900/516

(57) ABSTRACT

A trailer having a chassis, one or more wheels and a frame coupled to the chassis is provided for storing or hauling cargo. The frame includes a top member, a bottom member, a first side member, and a second side member which at least partially define an opening to an interior of the trailer. The trailer includes a door coupled to the frame and movable between a closed position, an open position, and a ramp position. A control system controls movement of the door and includes an actuator and a latching mechanism. In the open position, the door is pivotally coupled to the first side member of the frame, while in the closed position the door is coupled to the first side member and at least one of the top member and bottom member. In the ramp position, the door is pivotally coupled to the bottom member.

### RELATED APPLICATIONS

This application claims the benefit of U.S. Provisional Patent Application Ser. No. 63/696,500, filed Sep. 19, 2024, the disclosure of which is hereby incorporated by reference in its entirety.

### FIELD OF THE DISCLOSURE

The present disclosure relates to a trailer, and more particularly to a cargo trailer with a door and ramp assembly combination.

### BACKGROUND

Trailers, such as cargo trailers, are transportable storage units with wheels capable of being towed by a towing vehicle such as a truck or other vehicle. Trailers can include a hitch that is coupled to the towing vehicle. Moreover, trailers include an interior capable of storing items.

### SUMMARY

In one implementation of the present disclosure, a trailer includes a chassis; one or more wheels configured to support the chassis; a frame coupled to the chassis, the frame comprising a top member, a bottom member, a first side member, and a second side member, where the top member, bottom member, first side member and second side member at least partially define an opening to an interior of the trailer; a door coupled to the frame, the door configured to be movable between a closed position to at least partially close the opening, an open position, and a ramp position; and a control system configured to control a movement of the door, the control system including at least one actuator and at least one latching mechanism; wherein, in the open position the door is pivotally coupled to the first side member; wherein, in the closed position the door is coupled to the first side member and at least one of the top member and bottom member; wherein, in the ramp position the door is pivotally coupled to the bottom member.

In one example of this implementation, the door includes a sub-frame coupled to a bottom portion and a side portion of the door, the sub-frame configured to be releasably coupled to the first side member and bottom member in the open position. In a second example, the sub-frame is coupled to the frame and de-coupled from the door in the ramp position. In a third example, the sub-frame is coupled to the bottom member and first side member in the ramp position. In a fourth example, at least a portion of the sub-frame is disposed within a recess portion formed in the bottom member of the frame in the ramp position.

In a fifth example, the door includes an inner surface and an outer surface, the inner surface including a plurality of longitudinally-extending ribs and the outer surface defining a location to which the at least one actuator is coupled. In a sixth example, the at least one actuator includes a first actuator and a second actuator, the first actuator configured to releasably couple a first latching mechanism located on the door to the frame and the second actuator configured to releasably couple a second latching mechanism located on the door to the frame. In a seventh example, a splitter assembly is coupled to the first actuator, the second actuator, the first latching mechanism and the second latching mechanism, the splitter assembly configured to receive a first signal from the first actuator to controllably actuate the first latching mechanism and a second signal from the second actuator to controllably actuate the second latching mechanism.

In an eighth example, the frame includes a first latch pin and a second latch pin, the first latching mechanism configured to releasably engage with the first latch pin and the second latching mechanism configured to releasably engage with the second latch pin. In a ninth example, the second latch pin is disposed within a recess portion of the frame. In a tenth example, the door includes a third latching mechanism operably controlled by the first actuator or the second actuator.

In another example, the door pivots about a first axis when moving between the open position and closed position, and the door pivots about a second axis when moving between the closed position and the ramp position, where the first axis is perpendicular to the second axis. In a further example, a second door is coupled to the frame adjacent the door, the second door configured to be movable between a closed position, an open position, and a ramp position; wherein the control system is configured to control a movement of the second door; wherein, in the open position, the second door is pivotally coupled to the second side member; wherein, in the closed position, the second door is coupled to the second side member and at least one of the top member and bottom member; wherein, in the ramp position, the second door is pivotally coupled to the bottom member.

In another implementation of the present disclosure, a trailer includes a chassis; one or more wheels configured to support the chassis; a frame coupled to the chassis, the frame including a top member, a bottom member, a first side member, and a second side member, where the top member, bottom member; a door coupled to the frame, the door configured to be movable between a closed position, an open position, and a ramp position; and a control system configured to control a movement of the door, the control system including a user control and a plurality of latch assemblies; wherein, in the open position, the user control is located in a first position and the door is pivotally coupled to the first side member; wherein, in the closed position, the user control is located in a second position and the door is coupled to the first side member and at least one of the top member and bottom member; wherein, in the ramp position, the user control is located in a third position and the door is pivotally coupled to the bottom member.

In a first example of this implementation, when the user control is moved between the first position and the third position, the user control is moved from the first position or third position to the second position before being moved to the other of the first position or third position. In a second example, the user control includes a lever or switch.

In a further implementation of the present disclosure, a control system for controlling movement of a first door and a second door of a trailer includes a controller including a memory unit and a processor; a user control disposed in communication with the controller, the user control configured to transmit a signal to the controller indicative of a desired position of the first door or second door; at least a first actuator operably coupled to the first door, the at least first actuator disposed in communication with the controller; and at least one latching mechanism operably coupled to the at least first actuator, the at least one latching mechanism configured to be releasably engaged with a frame of the trailer; wherein, the first door is configured to be controllably moved between a closed position, an open position, and a ramp position relative to the frame; wherein, the controller is configured to receive the signal from the user control and communicate a second signal to the at least first actuator to actuate the at least one latching mechanism to move the first door between the closed position, open position and ramp position.

In one example of this implementation, a sensor is disposed in communication with the controller, the sensor configured to detect a position of the first door relative to the frame and communicate the position to the controller. In another example, a sensor is disposed in communication with the controller, the sensor configured to sense a presence of an object in an area surrounding the first door and communicate a second signal indicative of the presence of the object to the controller; wherein the controller receives the second signal from the sensor and is configured to determine whether to move the first door between the closed position, open position and ramp position. In a further example, at least a second actuator is operably coupled to the second door, the at least second actuator disposed in communication with the controller; a second latching mechanism is operably coupled to the at least second actuator, the second latching mechanism configured to be releasably engaged with the frame of the trailer; wherein, the second door is configured to be controllably moved between a closed position, an open position, and a ramp position relative to the frame; wherein, the controller is configured to receive the signal from the user control and communicate another signal to the at least second actuator to actuate the second latching mechanism to move the second door between the closed position, open position and ramp position.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side perspective view of a conventional cargo trailer;

FIG. 2 is another side view of the conventional cargo trailer of FIG. 1;

FIG. 3 is a partial rear side perspective view of one example implementation of a door and ramp combination of a cargo trailer;

FIG. 4 is another partial rear side perspective view of the door and ramp combination;

FIG. 5 is another partial rear side perspective view of the door and ramp combination;

FIG. 6 is a front view of a latch assembly of the door and ramp combination of FIG. 3;

FIG. 7 is a view of another latch assembly of the door and ramp combination of FIG. 3;

FIG. 8 is a view of a hinge and spring assembly of the door and ramp combination of FIG. 3;

FIG. 9 is a view of a portion of the door and ramp combination of FIG. 3;

FIG. 10 is a perspective view of another example implementation of a door and ramp combination of a cargo trailer;

FIG. 11 is a schematic of a control assembly for the door and ramp combination of FIG. 10;

FIG. 12 is another schematic of the control assembly of FIG. 11;

FIG. 13 is a partial perspective view of the door and ramp combination of FIG. 9 in a partially open position;

FIG. 14 is another schematic of the control assembly of FIG. 11;

FIG. 15 is a partial perspective view of the door and ramp combination of FIG. 9 in a partially deployed position; and

FIG. 16 is a schematic of a control system for controlling a door and ramp combination of a cargo trailer.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

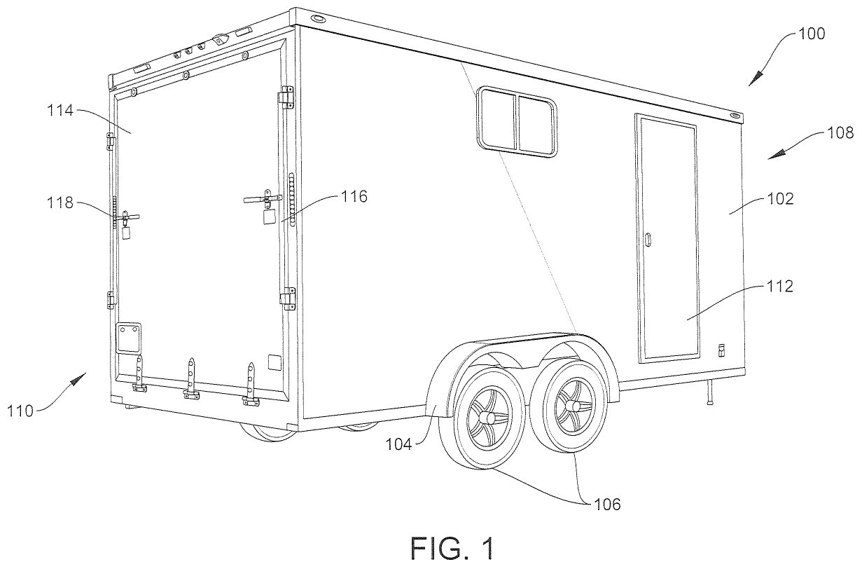

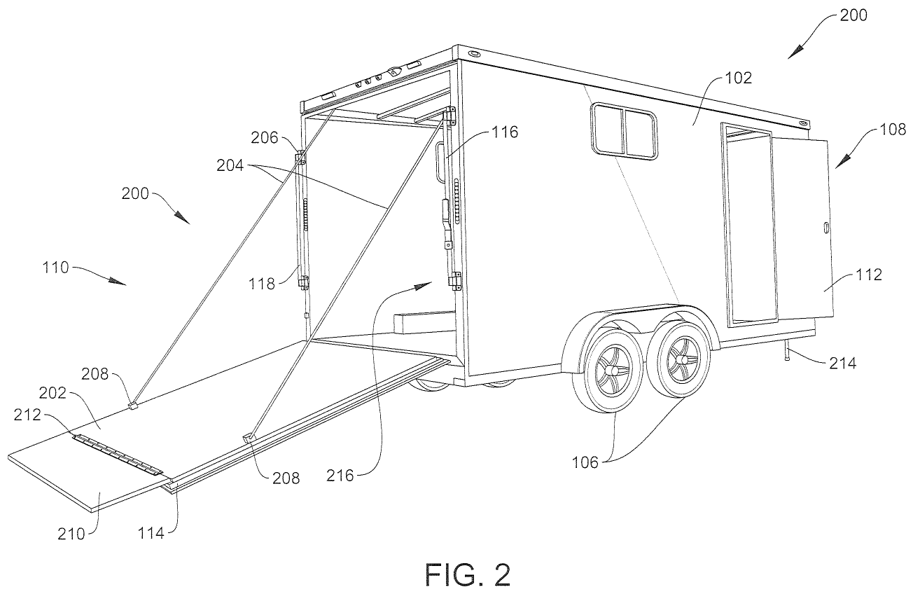

Referring to FIGS. 1 and 2 of the present disclosure, an example implementation of a transport trailer is illustrated. The transport trailer may be any transportable trailer including a cargo trailer, travel trailer, fifth wheel trailer, toy hauler, camping trailer, and/or truck camper. In FIG. 1, the example implementation of the trailer 100 includes a body 102 having a front end 108, a rear end 110, a top, a bottom, and a pair of opposing sides. The trailer 100 includes a chassis 104 to which the body 102 is coupled, and the chassis 104 is supported by one or more wheels 106 that facilitate transportation of the trailer 100. In this example implementation, the trailer 100 is a towable trailer without a power-generating system for powering the trailer. In other implementations, however, the trailer may take the form of a motorized trailer or recreational vehicle such as a motorhome. Thus, for purposes of this disclosure, the term “trailer” may be broadly construed in various implementations as a motorized or non-motorized, towable recreational vehicle or trailer.

In FIGS. 1 and 2, the trailer 100 is a non-motorized, towable trailer. Although not shown, the trailer 100 may include a towable hitch located at the front end 108 of the trailer 100 for releasably coupling to a towing vehicle or machine (not shown). The hitch (not shown) may engage with a U-shaped coupling component on a towing vehicle or machine where the coupling component is located in a bed of a truck or at a rear bumper of the towing vehicle or machine. Any type of hitch is contemplated by the present disclosure. As shown in FIGS. 1 and 2, the trailer 100 is in a rest position where a post 214 is deployed in a vertical orientation to support the front end 108 of the trailer 100 while the wheels 106 support the rear end 110 thereof. As is known, the post 214 may be pivoted to a generally horizontal position or at least out of contact with an underlying surface when the trailer 100 is hitched to a towing vehicle.

The body 102 of the trailer 100 may include a side door 112 formed in at least one side thereof. In FIG. 1, the side door 112 is shown in its closed position, whereas in FIG. 2 the side door 112 is shown in its open position. The trailer 100 may include more than one side door 112. For example, there may be a side door in each side of the trailer 100. In other implementations, there may not be any side door.

The trailer 100 is also shown with a conventional rear door 114. In FIG. 1, the rear door 114 is in a closed position. A first latch handle 116 and a second latch handle 118 may securely couple the rear door 114 to the body 102 to maintain or lock the rear door 114 in the closed position. When the first latch 116 and second latch handle 118 are actuated, the rear door 114 may be released from the closed position. In FIG. 2, for example, the rear door 114 may be deployed in a lowered or open position 200. In the lowered position 200 of FIG. 2, the rear door 114 may form a ramp having a ramp surface 202 which may support a person or object moving about the surface 202. A pair of cables 204 support the rear door 114 in the open position 200. Each cable 204 is coupled at one end 206 to the body 102 of the trailer 100 and at an opposite end 208 to the rear door 114.

In FIG. 2, the rear door 114 includes a transition member 210 that is hingedly coupled to the remainder of the rear door 114 via a hinge 212. The transition member 210 may be in contact with the underlying surface in the open position 200. When the rear door 114 is in the open position 200 of FIG. 2, an interior 216 of the trailer 100 is accessible to move items into or out of the trailer. In this manner, the trailer 100 is capable of storing and/or transporting items as needed.

The conventional rear door 114 of the trailer 100 in FIGS. 1 and 2 is limited to being opened in a ramp configuration, as shown in FIG. 2. The side door 112 of the trailer 100 is configured to open with side hinges. There is a desire, however, for a transport trailer to have a door or doors that can be opened in either a ramp configuration or door configuration to permit access to an interior of the trailer.

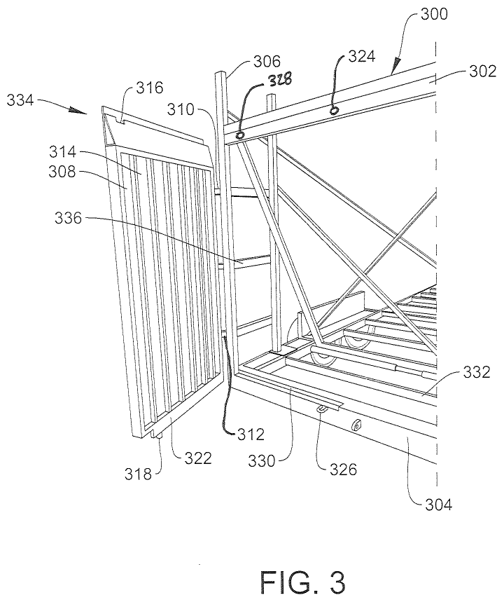

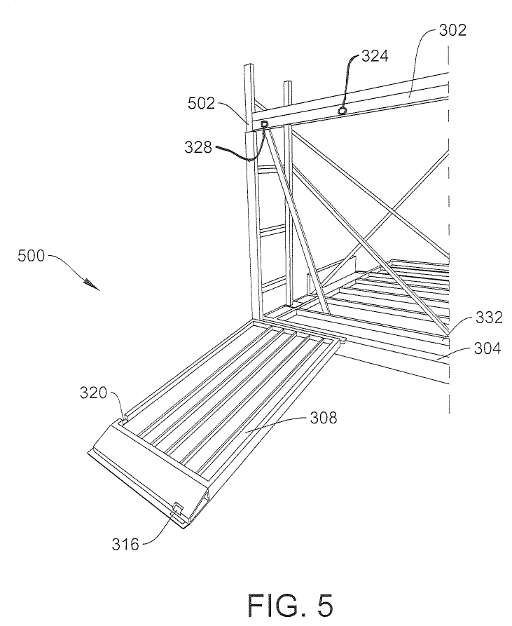

Referring to FIG. 3, another example implementation of a transportable trailer is shown. Here, a rear portion of a trailer frame 300 of the transportable trailer or cargo trailer is illustrated. The trailer may include a body and a chassis 332 similar to the trailer 100 of FIG. 1. The trailer frame 300 may include a top member 302, a bottom member 304, and a pair of opposing side members 306. The top member 302, bottom member 304, and pair of opposing side members 306 form a door frame configured to which a first door 308 and a second door (not shown) are coupled. The first door 308 is coupled to a first portion or half of the door frame and the second door is coupled to a second portion or other half of the door frame. In FIG. 3, the first door 308 is shown being pivotally coupled to the side member 306 via a first pivot 310, a second pivot 312, and a third pivot 336 (FIG. 5). In some implementations, each pivot may be a hinge or actuator for permitting pivotal movement between a closed position and open position.

The first door 308 includes a first catch or latching mechanism 316, a second catch or latching mechanism 318, and a third catch or latching mechanism 320 (FIG. 5). In other implementations, the first door 308 may include additional or fewer catches or latching mechanisms. In any event, the first latching mechanism 316 is configured to releasably engage a first latch pin 324. The second latching mechanism 318 is configured to releasably engage a second latch pin 326. As best shown in FIG. 5, the third latching mechanism 320 is configured to releasably engage a third latch pin 328.

In FIG. 3, the first door 308 is shown partially open. In this partially open configuration, an inner surface 314 of the first door 308 is shown.

The first door 308 may also include a sub-frame 322 to which it is coupled. The sub-frame 322 is located partially towards a bottom portion of the first door 308 and along at least one side thereof. In some configurations of the first door 308, the sub-frame 322 may be releasably coupled to the trailer frame 300. For example, in a ramp configuration 500 of FIG. 5, the sub-frame 322 is coupled to the bottom member 304 and side member 306 as the first door 308 is deployed to the ramp configuration 500. Thus, the sub-frame 322 does not move along with the first door 308 as the first door 308 moves to the ramp configuration 500.

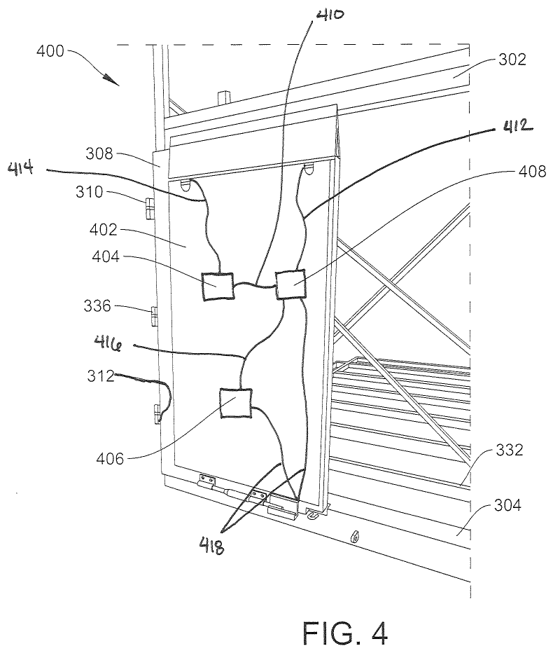

Moreover, the bottom member 304 of the trailer frame 300 includes a recess portion 330. The second latch pin 326 may be located in or adjacent to the recess portion 330. In some implementations, a portion of the sub-frame 322 may be disposed within the recess portion 330 when the first door 308 is in the closed position (see FIG. 4).

In the example implementation of FIGS. 3-5, the first door 308 may form part of a dual door and ramp combination with a second door (not shown). The first door 308 and second door may be disposed in an open configuration 334 (FIG. 3), a closed configuration 400 (FIG. 4), and a ramp or deployed configuration (FIG. 5). In the open configuration 334, the first door 308 and second door may open in a barn door-style configuration. In other implementations, there may only be the first door 308 that swings open about a generally vertical axis to the open configuration. In yet further implementations, the first door 308 may open as a garage door style manner whereby the first door 308 is located above the trailer or at least the interior thereof.

In FIGS. 3-5, the second door (not shown) may be releasably coupled to the trailer frame 300 in a manner similar to that of the first door 308. In other implementations, the second door may be fixedly coupled to the trailer frame 300 such that the second door does not open. In further implementations, the second door may be configured to only transition between the closed configuration 400 and the open configuration 334, or the second door may only transition between the closed configuration 400 and the ramp configuration 500.

Referring to FIG. 4, the first door 308 is disposed in its closed configuration or position 400. In this closed configuration, the first door 308 includes an outer surface 402. In this example implementation, the first door 308 includes a first control actuator 404 and a second control actuator 406. Upon actuation of the first control actuator 404, the first latch 316 on the first door 308 is released or decoupled from the first catch or pin 324 on the top member 302. Further, the third latch 320 on the first door 308 is released or decoupled from the third catch or pin 328 located on a second sub-frame portion 502. As this happens, the first door 308 may be lowered to its deployed or ramp configuration 500 of FIG. 5. As shown in FIG. 5, the second sub-frame portion 502 remains coupled to the side member 306 as the first door 308 moves to the ramp configuration 500. The first sub-frame portion 322 and second sub-frame portion 502 are configured to support the first door 308. A pin (not shown) may couple the first door 308 to the respective sub-frame portion to support the first door 308 and reduce any sag in the first door 308.

The first control actuator 404 may include a handle upon which a user manually actuates the first control actuator 404. One or more cables (see FIG. 4) may be mechanically coupled between the first control actuator 404 and the first latch 316 and the third latch 320 for transferring the actuating movement of the handle to the first and third latches 316, 320, respectively. Each of the one or more cables may be routed or connected to a splitter assembly 408 as shown in FIG. 4. The splitter assembly 408 is configured to assist with actuating the first latch 316 and the third latch 320. In one implementation, a first cable 410 may be coupled between the first control actuator 404 and the splitter assembly 408, a second cable 412 may be coupled between the splitter assembly 408 and the first latch 316, and a third cable 414 may be coupled between the first control actuator 404 and/or splitter assembly 408 and the third latch 320.

The second control actuator 406 may also include a handle upon which a user manually actuates the second control actuator 406. One or more cables may be mechanically coupled between the second control actuator 406 and the second latch 318. Each of the one or more cables may be routed or connected to the splitter assembly 408 as shown in FIG. 4. The splitter assembly 408 is configured to assist with actuating the second latch. In one implementation, one cable 416 may be coupled between the second control actuator 406 and the splitter assembly 408, and a second cable 418 may be coupled between the second control actuator 406 and/or splitter assembly 408 and the second latch 318.

Upon actuation of the second control actuator 406, the second latch 318 on the first door 308 is released or decoupled from the second catch or pin 326 on the bottom member 304. As this happens, the first door 308 may be pivoted in a swinging-like motion from the closed position 400 to the open configuration 334 of FIG. 3. In one implementation, the first door 308 operates as a barn-style door as it pivots between the closed and open configurations.

In an alternative implementation, the front door 308 may include a single handle capable of actuating one or more control actuators for controlling movement of the front door 308 between the closed configuration 400, open configuration 334, and ramp configuration 500. For example, the handle may be actuated in one direction to control actuation of one control actuator to control the release of the first and third latches, and the handle may be actuated in a second direction to control actuation of another control actuator to control the release of the second latch.

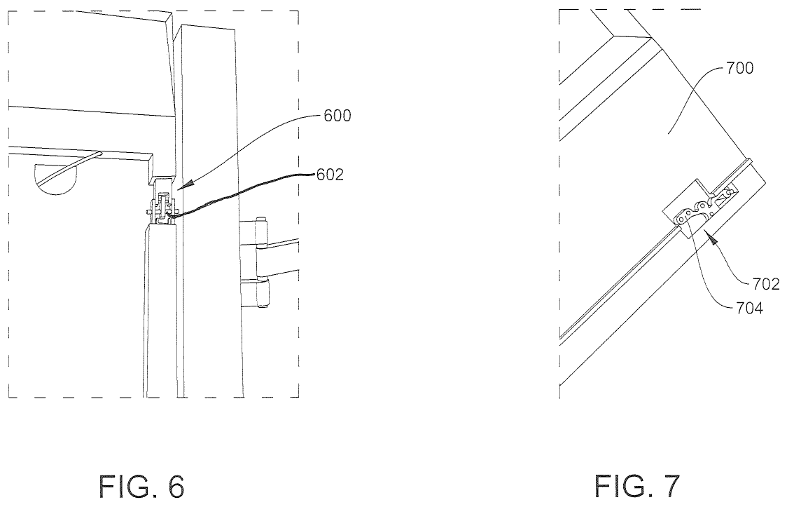

In FIG. 6, one implementation of a latch assembly 600 is illustrated. The latch assembly 600 may include any one of the first latch 316, second latch 318 and third latch 320. Moreover, the latch assembly 600 may include any one of the first catch or pin 324, the second catch or pin 326, and the third catch or pin 328. In FIG. 6, the latch assembly 600 is shown including a pin 602 to be engaged by a latch.

Referring to FIG. 7, another latch assembly 702 is illustrated on a door 700 such as the first door 308 or second door. The latch assembly 702 may include a biasing member such as a movable latch 704. The movable latch 704 may be biased, for example, by a spring (not shown). For example, the movable latch 704 may be biased in a closed or latched position. Upon actuation of a handle, a control actuator may initiate a counter movement of the movable latch 704 to compress the biasing member (i.e., a spring) or force the movable latch 704 in a direction opposite in which the biasing member is urging the movable latch 704.

In other implementations, the latch assembly of FIGS. 3-7 may be a cam bar lock that at least partially wraps around a bar or pin. Other latch assemblies may be used for controlling movement of the respective door.

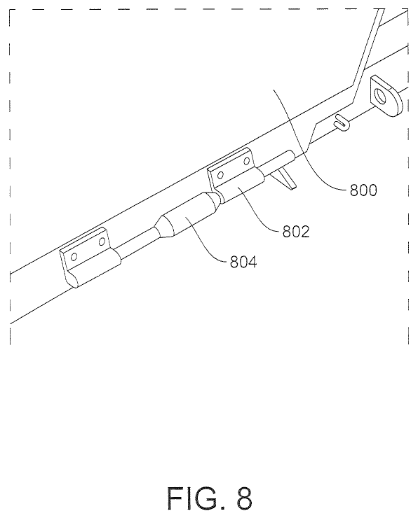

Referring to FIG. 8, a bottom portion of the connection between a door 800 and a trailer frame or sub-frame is shown. The door 800 may be similar to the first door 308 of FIG. 3. As shown, the door 800 may be pivotally coupled to the trailer frame or sub-frame. In some implementations, the door 800 may be pivotally coupled to a bottom member 304 of the trailer frame 300. In other implementations, the door 800 may be pivotally coupled to a first sub-frame portion 322. In some implementations, a pivot bar 802 may be provided about which the door 800 pivots. Moreover, a spring 804 may be provided as a biasing member. The spring 804 is configured to lighten the weight of the door 800 as it moves to the ramp configuration. For instance, as the door 800 is moved from the closed configuration to the ramp configuration, the spring 804 may be compressed during the movement to reduce the weight of the door 800 during the movement. In other words, the spring 804 may absorb some of the weight of the door 800.

In some implementations, there may be one or more seals interposed between the door 308 and trailer frame 300 or the door 308 and sub-frame. For example, a first seal may be disposed about the top member 302, bottom member 304, or side member 306 of the trailer frame 300. In the closed configuration 400 of FIG. 4, the inner surface 314 of the first door 308 may contact the first seal to form a sealing engagement between the first door 308 and the trailer frame 300. In another implementation, a second seal may be disposed between the first sub-frame portion 322 and/or second sub-frame portion 502 and the first door 308. In this manner, a sealing engagement is established between the first door 308 and respective sub-frame portion. The seals may prevent dirt, debris, water, snow, ice, bugs, etc. from getting into an interior of the trailer.

In a further implementation, another latch assembly may be operably coupled between the first door 308 and second door (not shown). In this implementation, when the doors are in the closed configuration, the latch assembly may operably couple the doors to one another. When either door moves to an open configuration 334, the latch assembly may be released or decoupled to permit movement of one door relative to the other door. Moreover, when the first door 308 and second door are moved to the ramp configuration 500, the latch assembly may remain engaged to maintain the coupling between the first and second doors. In this manner, the first and second doors may be coupled to one another to form a more uniform, level ramp surface when in the ramp configuration 500. In other implementations, the first and second door may not be coupled to one another. In these other implementations, the first door may form a ramp surface that is offset or angled relative to the ramp surface formed by the second door. This arrangement may allow the doors to assist with changes in elevation or topography upon deployment to the ramp configuration 500.

In still another implementation, door sweeps or finger sweeps may be disposed between the first and second door. The door sweeps or fingers sweeps may form a sealing function between the first and second doors to reduce or prevent water and other contaminants from passing into the trailer. In some implementations, the door sweeps or finger sweeps may be water-proof seals.

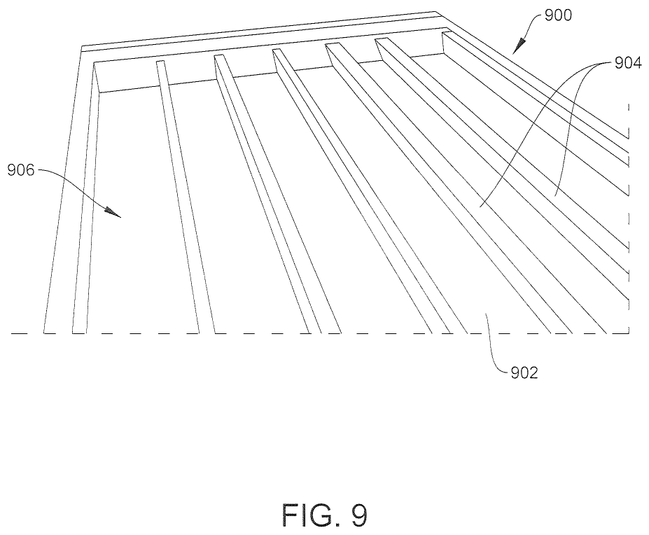

In a further implementation of FIG. 9, a door 900 is shown similar to the first door 308 of FIG. 3. The door 900 includes an inner surface 902 with a plurality of longitudinally-extending ribs 904. The plurality of ribs 904 are shown spaced from one another such that a space or cavity is defined between a pair of adjacent ribs 904. In some implementations, the control actuators, splitter assembly 408, and cables may be located within the spaces or cavities 906 shown in FIG. 9. Thus, only the first and second handle may be located outside of the door for actuation by a user.

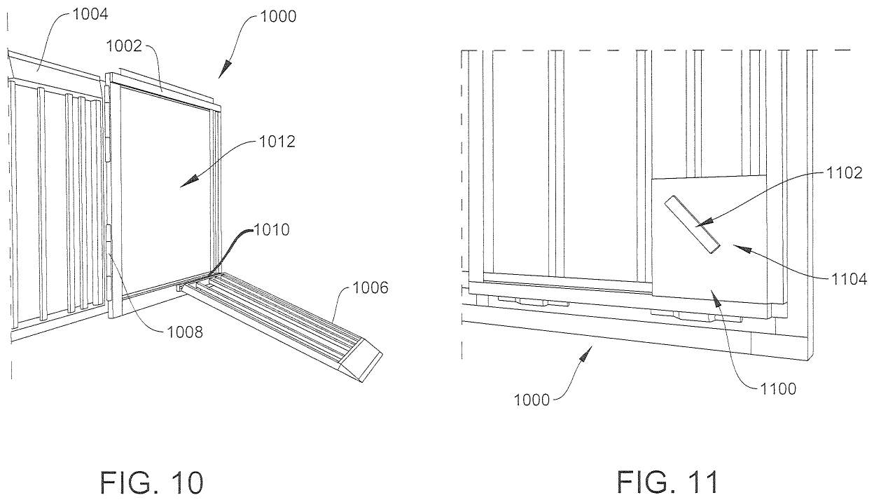

Referring now to FIGS. 10-15, another example implementation of the present disclosure is provided. In FIG. 10, for example, a trailer door assembly 1000 is illustrated. The trailer door assembly 1000 includes a frame 1002 for accommodating at least a first door 1004 and a second door 1006. The first door 1004 is shown in an open configuration where the first door 1004 is pivotally coupled to the frame 1002 via a first hinge assembly 1008. Likewise, the second door 1006 is shown in a ramp configuration where the second door 1006 is pivotally coupled to the frame 1002 via a second hinge assembly 1010. When either door is in the open configuration or ramp configuration, an access opening 1012 is formed to the interior of the trailer.

In this example implementation, a control assembly 1100 is provided for controlling movement of either door. The control assembly 1100 includes a user control 1102 such as a lever or switch. In the implementation of FIG. 11, the user control 1102 is disposed in a first position 1104 corresponding to a locked configuration. In the first position 1104, the user control 1102 may control actuation of one or more latch assemblies to maintain the first door 1004 or second door 1006 in the locked configuration. The locked configuration may also be referred to as a closed configuration similar to that of FIG. 4.

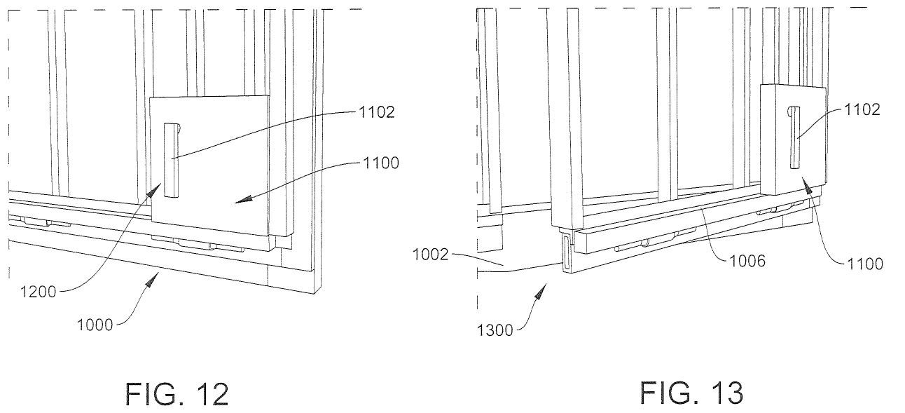

Referring to FIG. 12 of the present disclosure, the user control 1102 may be movable to a second position 1200 indicative of an open or barn-style configuration. As shown in FIG. 13, when the user control 1102 is moved to the second position 1200, one or more latch assemblies are released or disengaged thereby allowing the door (e.g., the second door 1006) to move from the closed configuration of FIG. 11 to an open configuration 1300 of FIG. 13.

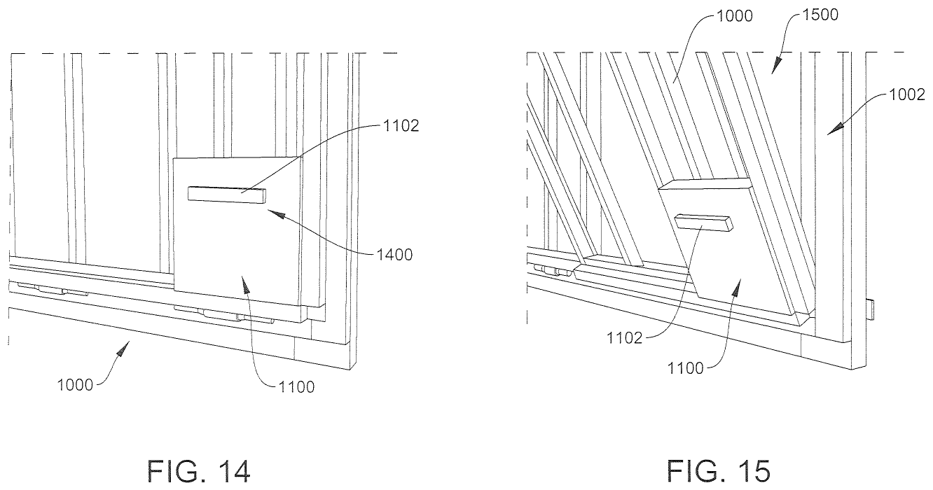

Turning to FIG. 14 of the present disclosure, the user control 1102 may be movable to a third position 1400 indicative of a ramp configuration. As shown in FIG. 15, when the user control 1102 is moved to the third position 1400, one or more latch assemblies are released or disengaged thereby allowing the door (e.g., the second door 1006) to move from the closed configuration of FIG. 11 to a ramp configuration 1500 of FIG. 15.

In the aforementioned example implementation of FIGS. 10-15, the user control 1102 is movable between the first position 1104 and either the second position 1200 or third position 1400. The user control 1102 is not controllable directly between the second position 1200 and third position 1400 without first going to the first position 1104. This is partly due to different latch assemblies being engaged or disengaged in the various positions.

In some implementations of the present disclosure, the door (e.g., first door 308, 1004 and second door 1006) may be formed of steel or aluminum. In other implementations, the door may be formed of composite.

In other implementations, a detachable hinge may be incorporated between the door and trailer frame to reduce or eliminate the different sub-frame portions described herein.

In further implementations, the control of the door between the closed, open and ramp configurations may be performed electronically. For example, an electronic control system may be implemented with a controller and at least one electric actuator for controlling the movement of the door. The controller may control via one or more solenoids the engagement and disengagement of latch assemblies between the door and the trailer frame or sub-frame portion. Moreover, the at least one actuator may include a first electric actuator for controlling movement of the door from the closed configuration to the open configuration, and another electric actuator may control movement between the closed configuration and ramp configuration. In some implementations, the controller may control movement of the door from the ramp configuration to the closed configuration and vice versa, as well as from the closed configuration to the open configuration and vice versa.

In yet other implementations, a hydraulic control system may be used for controlling the movement of a door between the closed, open and ramp configurations. The hydraulic control system may include a controller, a reservoir for storing hydraulic fluid, at least one control actuator that is hydraulically powered, and a valving system for controlling the flow of hydraulic fluid between the reservoir and at least one control actuator. The valving system may include one or more solenoids in some implementations that are electrically controlled by the controller to actuate a valve in the valving system for directing hydraulic fluid therethrough and for controlling movement of the control actuator and/or door.

In a further implementation, a pneumatic control system may be used for controlling the movement of a door between the closed, open and ramp configurations. The pneumatic control system may include a controller, an air or gas source, and a pneumatic actuator that is configured to be controlled to actuate the door between the closed, open and ramp configurations. Other control systems may be used including electro-mechanical, electro-hydraulic, electro-pneumatic, or any combination thereof.

In some implementations, a key fob or remote control may be actuated by a user to send commands to a controller to control movement of the door between any of the different configurations.

In other implementations, one or more sensors may be provided on the trailer or door to detect a position of the door as well as the position of each latch assembly. The one or more sensors may be in electric communication with a controller. In some implementations, a display on a mobile device such as a mobile phone, laptop, tablet or on a display in a towing vehicle may show the status of the door as well as the different latches. In other implementations, one or more sensors may detect movement of the door and further detect if an object is in the potential path of movement of the door. In further implementations, the controller may be programmed with software or control algorithms to prevent movement of the door along a path if a sensor detects an object. The sensor may be a proximity sensor or any other known type of sensor.

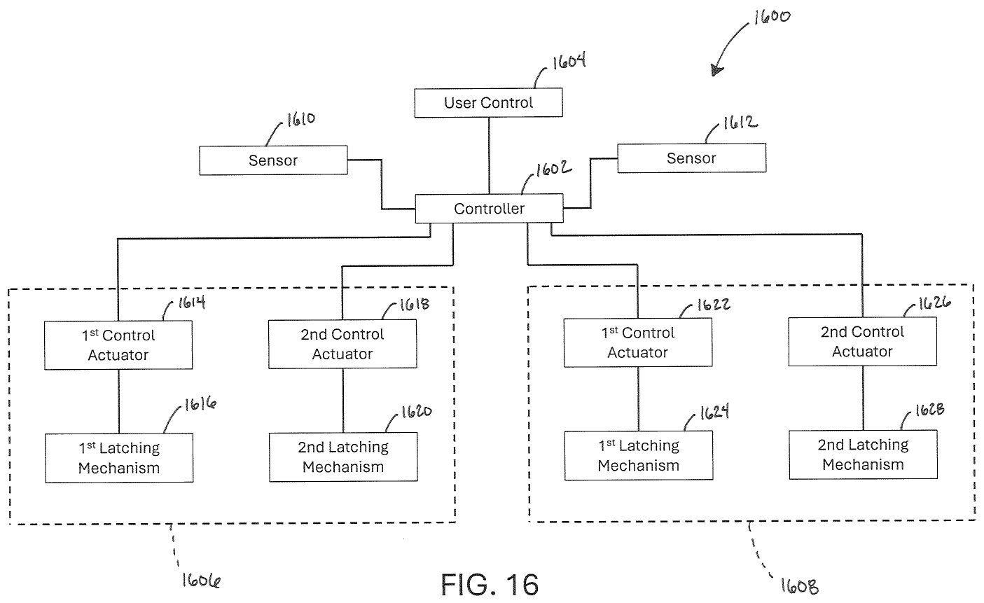

In one implementation of the present disclosure, a control system 1600 for controlling movement of one or more doors on a trailer is provided. In FIG. 16, the control system 1600 may control movement of the one or more doors between a closed, an open and ramp configurations. In the control system 1600, a controller 1602 may control the operation of the one or more doors. The controller 1602 may include a memory unit and a processor such that the memory unit may store programs, software, algorithms, and/or control logic to be executed by the processor when controlling the one or more doors. The controller 1602 may be configured to control other functions on the trailer besides the one or more doors.

In FIG. 16, the control system 1600 may include one or more sensors. The one or more sensors may be configured to detect a position of the one or more doors, a position of a latch assembly, a movement of the one or more doors, a location of the one or more doors relative to the trailer, an object in a path of movement of the one or more doors, and the like. In FIG. 16, the one or more sensors may include at least a first sensor 1610 and a second sensor 1612. The first sensor 1610 may be configured to detect a characteristic of a first door 1606 of the one or more doors on the trailer. The first sensor 1610 may be located on the first door 1606 or on a frame of the trailer. Similarly, the second sensor 1612 may be configured to detect a characteristic of a second door 1608 of the one or more doors on the trailer. For purposes of this implementation, the first door 1606 and second door 1608 may be similar to the doors 308, 700, 800, 900, 1004, 1006 described herein. In one example, the first sensor 1610 may be configured to detect a position or configuration of the first door 1606 relative to the trailer frame (e.g., closed, open or ramp configuration). In another example, the second sensor 1612 may be configured to detect a position or configuration of the second door 1608 relative to the trailer frame (e.g., closed, open or ramp configuration).

In FIG. 16, the first door 1606 may be operably controlled between a closed configuration, an open configuration, and a ramp configuration by one or more actuators. In the illustrated implementation, the one or more actuators includes a first control actuator 1614 and a second control actuator 1618. The first control actuator 1614 may operably control a position of a first latching mechanism 1616, and the second control actuator 1618 may operably control a position a second latching mechanism 1620. Although not shown, a splitter assembly may be provided in communication with the first and second control actuators.

As also shown in FIG. 16, the second door 1608 may be operably controlled between a closed configuration, an open configuration, and a ramp configuration by one or more actuators. In the illustrated implementation, the one or more actuators includes a first control actuator 1622 and a second control actuator 1626. The first control actuator 1622 may operably control a position of a first latching mechanism 1624, and the second control actuator 1626 may operably control a position a second latching mechanism 1628. Although not shown, a splitter assembly may be provided in communication with the first and second control actuators.

The control of each control actuator of the first door 1606 and second door 1608 may be via a user control 1604. In some implementations, the user control 1604 may be a handle configured to operably control movement of the first or second control actuator on either door. In other implementations, the user control 1604 may be a button or switch on the door or trailer for controlling one of the control actuators or latching mechanisms. In yet another implementation, the user control 1604 may be on a remote device such as a key fob, mobile device, or button on a display in the trailer. The present disclosure intends to allow control of the first door 1606 and second door 1608 via an application executable on a mobile device, laptop, computing device, and the like. Thus, a user may be located remote from the trailer and yet still able to control movement of either door. In some implementations, the first sensor 1610, second sensor 1612, or another sensor may detect a surrounding area of the trailer to ensure no object or person is in the area as the first door 1606 or second door 1608 is moved to a different configuration. If any one of the sensors detects an object, the sensor may send a signal to the controller 1602 to discontinue the controlling movement of the door. The controller 1602 may also send a signal to the user control, display, mobile device, laptop, computing device, etc. communicating the presence of an object and thus disallowing the door from moving to the desired configuration until the object is no longer detected. The sensor may continuously detect for an object and communicate a signal to the controller 1602.

In some implementations, a power assist function may be provided to control movement of the door between the closed, open, and ramp configurations.

In yet other implementations, a flap or other object may be disposed between the trailer frame and the door when the door is in the ramp configuration. The flap may be coupled to the door to reduce any gap or space between, for example, a first door and a second door in the ramp configuration. In some implementations, the flap may be spring loaded to bias the flap either upward or downward to cover the gap.

While the previous implementations refer to the door on a rear of a transport trailer, the same implementations may apply to any door on the trailer. This may include, for example, a side door or front door.

The previously described implementations in FIGS. 3-16 of the present disclosure offer various door and ramp combinations that allow for an integrated ramp and barn door style combination for transport trailers such as cargo trailers. As described, the door is configured to function as a swing or barn door as well as a ramp. The door is able to be moved to either configuration independently whereas one side of the door functions as a ramp surface and the other side functions as a barn door. As also described, these implementations do not require the tension cables such as cables 204 in FIG. 2 when deployed in the ramp configuration. Without these tension cables, a wider opening is achievable and use of the ramp is unencumbered. Further, the tension cables often require overhead ramp spring, and the removal of the cables and springs can improve the safety for those using or maintaining the trailer.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A trailer, comprising:
a chassis;
one or more wheels configured to support the chassis;
a frame coupled to the chassis, the frame comprising a top member, a bottom member, a first side member, and a second side member, where the top member, bottom member, first side member and second side member at least partially define an opening to an interior of the trailer;
a door coupled to the frame, the door configured to be movable between a closed position to at least partially close the opening, an open position, and a ramp position; and
a control system configured to control a movement of the door, the control system including at least one actuator and at least one latching mechanism;
wherein, in the open position the door is pivotally coupled to the first side member;
wherein, in the closed position the door is coupled to the first side member and at least one of the top member and bottom member;
wherein, in the ramp position the door is pivotally coupled to the bottom member.

2. The trailer of claim 1, wherein the door comprises a sub-frame coupled to a bottom portion and a side portion of the door, the sub-frame configured to be releasably coupled to the first side member and bottom member in the open position.

3. The trailer of claim 2, wherein, in the ramp position, the sub-frame is coupled to the frame and de-coupled from the door.

4. The trailer of claim 3, wherein the sub-frame is coupled to the bottom member and first side member in the ramp position.

5. The trailer of claim 3, wherein at least a portion of the sub-frame is disposed within a recess portion formed in the bottom member of the frame in the ramp position.

6. The trailer of claim 1, wherein the door comprises an inner surface and an outer surface, the inner surface including a plurality of longitudinally-extending ribs and the outer surface defining a location to which the at least one actuator is coupled.

7. The trailer of claim 1, wherein the at least one actuator comprises a first actuator and a second actuator, the first actuator configured to releasably couple a first latching mechanism located on the door to the frame and the second actuator configured to releasably couple a second latching mechanism located on the door to the frame.

8. The trailer of claim 7, further comprising a splitter assembly coupled to the first actuator, the second actuator, the first latching mechanism and the second latching mechanism, the splitter assembly configured to receive a first signal from the first actuator to controllably actuate the first latching mechanism and a second signal from the second actuator to controllably actuate the second latching mechanism.

9. The trailer of claim 7, wherein the frame comprises a first latch pin and a second latch pin, the first latching mechanism configured to releasably engage with the first latch pin and the second latching mechanism configured to releasably engage with the second latch pin.

10. The trailer of claim 9, wherein the second latch pin is disposed within a recess portion of the frame.

11. The trailer of claim 7, wherein the door comprises a third latching mechanism operably controlled by the first actuator or the second actuator.

12. The trailer of claim 1, wherein the door pivots about a first axis when moving between the open position and closed position, and the door pivots about a second axis when moving between the closed position and the ramp position, where the first axis is perpendicular to the second axis.

13. The trailer of claim 1, further comprising a second door coupled to the frame adjacent the door, the second door configured to be movable between a closed position, an open position, and a ramp position;
wherein the control system is configured to control a movement of the second door;
wherein, in the open position, the second door is pivotally coupled to the second side member;
wherein, in the closed position, the second door is coupled to the second side member and at least one of the top member and bottom member;
wherein, in the ramp position, the second door is pivotally coupled to the bottom member.

14. A trailer, comprising:
a chassis;
one or more wheels configured to support the chassis;
a frame coupled to the chassis, the frame comprising a top member, a bottom member, a first side member, and a second side member, where the top member, bottom member;
a door coupled to the frame, the door configured to be movable between a closed position, an open position, and a ramp position; and
a control system configured to control a movement of the door, the control system including a user control and a plurality of latch assemblies;
wherein, in the open position, the user control is located in a first position and the door is pivotally coupled to the first side member;
wherein, in the closed position, the user control is located in a second position and the door is coupled to the first side member and at least one of the top member and bottom member;
wherein, in the ramp position, the user control is located in a third position and the door is pivotally coupled to the bottom member.

15. The trailer of claim 14, wherein, when the user control is moved between the first position and the third position, the user control is moved from the first position or third position to the second position before being moved to the other of the first position or third position.

16. The trailer of claim 14, wherein the user control comprises a lever or switch.

17. A control system for controlling movement of a first door and a second door of a trailer, comprising:
a controller including a memory unit and a processor;
a user control disposed in communication with the controller, the user control configured to transmit a signal to the controller indicative of a desired position of the first door or second door;
at least a first actuator operably coupled to the first door, the at least first actuator disposed in communication with the controller; and
at least one latching mechanism operably coupled to the at least first actuator, the at least one latching mechanism configured to be releasably engaged with a frame of the trailer;
wherein, the first door is configured to be controllably moved between a closed position, an open position, and a ramp position relative to the frame;
wherein, the controller is configured to receive the signal from the user control and communicate a second signal to the at least first actuator to actuate the at least one latching mechanism to move the first door between the closed position, open position and ramp position.

18. The control system of claim 17, further comprising a sensor disposed in communication with the controller, the sensor configured to detect a position of the first door relative to the frame and communicate the position to the controller.

19. The control system of claim 17, further comprising a sensor disposed in communication with the controller, the sensor configured to sense a presence of an object in an area surrounding the first door and communicate a second signal indicative of the presence of the object to the controller;
wherein the controller receives the second signal from the sensor and is configured to determine whether to move the first door between the closed position, open position and ramp position.

20. The control system of claim 17, further comprising:
at least a second actuator operably coupled to the second door, the at least second actuator disposed in communication with the controller;
a second latching mechanism operably coupled to the at least second actuator, the second latching mechanism configured to be releasably engaged with the frame of the trailer;
wherein, the second door is configured to be controllably moved between a closed position, an open position, and a ramp position relative to the frame;
wherein, the controller is configured to receive the signal from the user control and communicate another signal to the at least second actuator to actuate the second latching mechanism to move the second door between the closed position, open position and ramp position.
